(19) United States
(12) Patent Application Publication
(10) Pub. No.: US 2007/0222852 A1
(43) Pub. Date: Sep. 27, 2007

(54) Method for providing video communication service, and terminal and system therefor

(75) Inventor: Woo-Suk Jang, Hwaseong-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/715,677

(22) Filed: Mar. 8, 2007

(30) Foreign Application Priority Data
Mar. 10, 2006 (KR) 10-2006-0022678

(51) Int. Cl. H04N 7/14

(52) U.S. Cl. 348/14.01

(57) ABSTRACT

Provided is a method for providing a video communication service of a dual mode mobile terminal in a system having a dual mode mobile terminal that can communicate with a first communication system and a second communication system enabling the video communication service. The method includes, upon receipt by the dual mode mobile terminal of a call for video communication, in the first communication system, transmitting a video call reception notification message for notifying to the dual mode mobile terminal that a video call is received; and in the dual mode mobile terminal, upon receipt of the video call reception notification message, switching a first communication mode for communication with the first communication system to a second communication mode for communication with the second communication system, and executing an operation based on video call reception using the second communication system.

### PRIORITY

This application claims priority under 35 U.S.C. § 119 to an application entitled “Method For Providing Video Communication Service, And Terminal And System Therefore” filed in the Korean Intellectual Property Office on Mar. 10, 2006 and assigned Serial No. 2006-22678, the contents of which are incorporated herein by reference.

### BACKGROUND OF THE INVENTION

1. Field of the Invention

The present invention relates generally to a method for providing a video communication service to a dual mode mobile terminal, positioned in a boundary where video communication service is possible, but, which does not connect with a communication system for video communication service, in a mobile communication system providing communication services based on varying modes, and a terminal and a system therefore.

2. Description of the Related Art

Presently, a Code Division Multiple Access (CDMA) system is already widely distributed in its service boundary, and is complete with an infrastructure. A third generation (3G) network such as a Wideband Code Division Multiple Access (WCDMA) system is being gradually introduced for providing a service that cannot be supported in a second generation (2G) network such as a CDMA system. A dual mode mobile terminal, which is designed to use an infrastructure of the 2G networks while receiving a specified service of the 3G networks in a boundary where the 3G networks is installed, is being developed.

Accordingly, in recent years, a necessity to provide, to a user, a mobile terminal capable of operating in the CDMA network system as well as both WCDMA and CDMA network systems have prompted the development of a dual mode user equipment or dual mode mobile terminal for supporting WCDMA and CDMA systems.

FIG. 1 illustrates a boundary where conventional CDMA network and WCDMA network systems are installed. The boundary is primarily divided as a CDMA single boundary where only CDMA service is possible, and an overlap boundary where both CDMA service and WCDMA service are simultaneously supportable.

Referring to FIG. 1, in an overlap boundary 160, the dual mode mobile terminal 100 performs an operation based on a WCDMA mode within a WCDMA network. However, upon the dual mode mobile terminal 100 entering the CDMA single boundary 150, if unable to locate a WCDMA base transceiver station, it searches for a CDMA base transceiver station. Thereafter, the dual mode mobile terminal 100, upon locating the CDMA base transceiver station switches to the CDMA mode and completes roaming. Alternatively, when the dual mode terminal 100 enters the overlap boundary 160 operating in the CDMA mode, it performs the roaming to again switch the CDMA mode to the WCDMA mode according to a predetermined condition.

The dual mode mobile terminal can receive a video communication service. The video communication service can be provided using the WCDMA network system.

However, in case where entering the overlap boundary 160, the dual mode mobile terminal 100 continues to operate in the CDMA mode without switching the CDMA mode to the WCDMA mode, video communication transmission is not possible until the CDMA mode is switched to the WCDMA mode. Even though a terminal user is positioned in the overlap boundary 160 that is a position where video communication is possible, video communication reception is impossible when the terminal is not switched to be in the WCDMA mode.

As described above, a shortcoming of the conventional art is that, even though the dual mode mobile terminal is positioned in the CDMA/WCDMA overlap boundary and enables the video communication service, if the terminal is operated in the CDMA mode and is connected to the CDMA network system, video communication reception/transmission is impossible.

### SUMMARY OF THE INVENTION

It is, therefore, an object of the present invention to provide a method for, in case where a dual mode mobile terminal positioned in a CDMA/WCDMA overlap boundary connects to a CDMA network system, enabling video communication reception/transmission, and a terminal and a system therefore.

It is an aspect of the present invention to provide a method for, in case where a dual mode mobile terminal positioned in a CDMA/WCDMA overlap boundary connects to a CDMA network system, automatically executing a switching operation to a WCDMA mode in response to an input for video communication transmission as well as enabling video communication transmission, and a terminal and a system therefore.

It is a further aspect of the present invention to provide a method for, in case where a dual mode mobile terminal positioned in a CDMA/WCDMA overlap boundary connects to a CDMA network system and receives video communication, automatically executing a switching operation to a WCDMA mode as well as enabling video communication reception, and a terminal and a system therefore.

In order to achieve the above and other aspects of the present invention, there is provided a method for enabling a video communication service of a dual mode mobile terminal in a system having a dual mode mobile terminal that can communicate with a first communication system and a second communication system providing the video communication service. The method includes, upon receipt by the dual mode mobile terminal of a call for video communication, in the first communication system, transmitting a video call reception notification message for indicating to the dual mode mobile terminal that a video call is received, depending on whether the dual mode mobile terminal is positioned in an overlap boundary of the first and second communication systems; and in the dual mode mobile terminal, upon receipt of the video call reception notification message, switching a first communication mode for communication with the first communication system to a second communication mode for communication with the second communication system, and executing an operation based on video call reception using the second communication system.

According to another aspect of the present invention, there is provided a method for enabling a video communication service of a dual mode mobile terminal in a system having the dual mode mobile terminal that can communicate with a first communication system and a second communication system providing the video communication service. The method includes, upon receipt by the dual mode mobile terminal of a call for video communication, in the first communication system, transmitting a video call reception notification message for notifying that a video call is received; and in the dual mode mobile terminal, upon receipt of the video call reception notification message, determining whether it is positioned in an overlap boundary of the first and second communication systems, and, when it is positioned in the overlap boundary of the first and second communication systems, switching a first communication mode for communication with the first communication system to a second communication mode for communication with the second communication system, and executing an operation based on video call reception using the second communication system.

According to still further another aspect of the present invention, there is provided a method for controlling video communication transmission in a dual mode mobile terminal in a system having the dual mode mobile terminal that can communicate with a first communication system and a second communication system providing a video communication service. The method includes, when there is an input for the video communication transmission, determining whether a communication operation mode is a first communication mode for communication with the first communication system, and, when the communication operation mode is the first communication mode, determining whether a current position is in an overlap boundary of the first and second communication systems; if it is determined that the current position is in the overlap boundary of the first and second communication systems, switching the first communication mode to a second communication mode for communication with the second communication system; and in response to the transition to the second communication mode, executing an operation based on video call reception using the second communication system.

According to yet another aspect of the present invention, there is provided a system having a dual mode mobile terminal that can communicate with a first communication system and a second communication system providing a video communication service, and providing the video communication service of the dual mode mobile terminal. The system includes the first communication system for, upon receipt by the dual mode mobile terminal of a call for video communication, transmitting a video call reception notification message for indicating to the dual mode mobile terminal that a video call is received, depending on whether the dual mode mobile terminal is positioned in an overlap boundary of the first and second communication systems; and the dual mode mobile terminal for, upon receipt of the video call reception notification message, switching a first communication mode for communication with the first communication system to a second communication mode for communication with the second communication system, and executing an operation based on video call reception using the second communication system.

In yet still another aspect of the present invention, there is provided a system having a dual mode mobile terminal that can communicate with a first communication system and a second communication system enabling a video communication service, and providing the video communication service of the dual mode mobile terminal. The system includes the first communication system for, upon receipt by the dual mode mobile terminal of a call for video communication, transmitting a video call reception notification message for indicating to the dual mode mobile terminal that a video call is received; and the dual mode mobile terminal for, upon receipt of the video call reception notification messages, determining whether it is positioned in an overlap boundary of the first and second communication systems, and, when it is positioned in the overlap boundary of the first and second communication systems, switching a first communication mode for communication with the first communication system to a second communication mode for communication with the second communication system, and executing an operation based on video call reception using the second communication system.

In further still another aspect of the present invention, there is provided a dual mode mobile terminal for controlling video communication transmission in a system having the dual mode mobile terminal that can communicate with a first communication system and a second communication system enabling a video communication service. The terminal includes a first modem for executing a first communication mode for communication with the first communication system; a second modem for executing a second communication mode for communication with the second communication system; and a controller for, when there is an input for video communication transmission, determining whether a communication operation mode is the first communication mode, and, when the communication operation mode is the first communication mode, determining whether a current position is in an overlap boundary of the first and second communication systems, and, when the current position is in the overlap boundary of the first and second communication systems, switching the first communication mode to the second communication mode for the communication with the second communication system, and executing an operation based on video call reception using the second communication system.

In yet still another aspect of the present invention, there is provided a dual mode mobile terminal for controlling video communication transmission in a system having the dual mode mobile terminal that can communicate with a first communication system and a second communication system enabling a video communication service. The terminal includes a first modem for executing a first communication mode for communication with the first communication system; a second modem for executing a second communication mode for communication with the second communication system; and a controller for, upon receipt of a video call reception notification message from the first communication system in execution of the first communication mode, switching the first communication mode to the second communication mode, and executing an operation based on video call reception using the second communication system.

In yet still further another aspect of the present invention, there is provided a dual mode mobile terminal for controlling video communication reception in a system having the dual mode mobile terminal that can communicate with a first communication system and a second communication system enabling a video communication service. The terminal includes a first modem for executing a first communication mode for communication with the first communication system; a second modem for executing a second communication mode for communication with the second communication system; and a controller for, upon receipt of a video call reception notification message from the first communication system in execution of the first communication mode, determining whether it is in an overlap boundary of the first and second communication systems, switching the first communication mode into the second communication mode, and executing an operation based on video call reception using the second communication system.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating boundaries where conventional CDMA network and WCDMA network systems are installed;

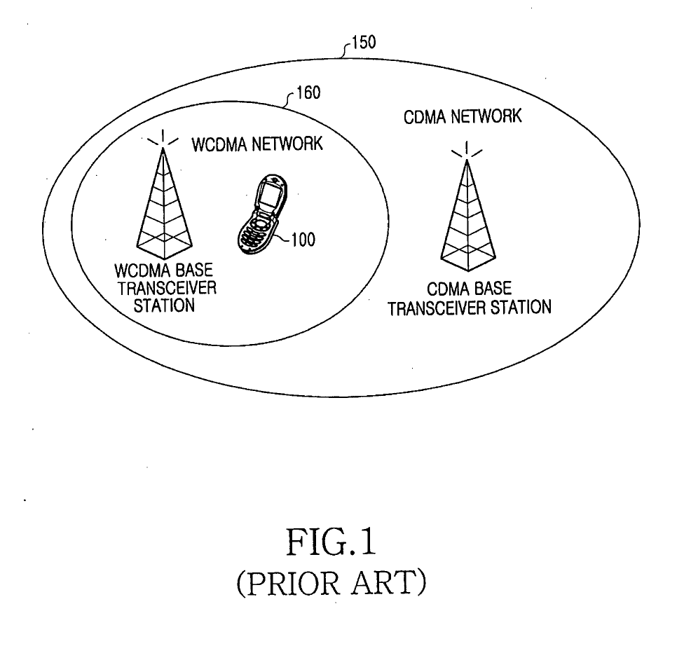

FIG. 2 is a block diagram illustrating internal constructions of a dual mode mobile terminal and CDMA network and WCDMA network systems according to the present invention;

FIG. 3 is a control flowchart for processing video communication transmission in a dual mode mobile terminal according to the present invention;

FIG. 4 is a signal flowchart between CDMA network and WCDMA network systems and a dual mode mobile terminal, for processing video communication reception by the dual mode mobile terminal according to a first embodiment of the present invention;

FIG. 5 is a signal flowchart between CDMA network and WCDMA network systems and a dual mode mobile terminal, for processing video communication reception by the dual mode mobile terminal according to a second embodiment of the present invention; and

FIG. 6 is a view of a screed illustrating an example of a screen displayed on a dual mode mobile terminal depending on video communication reception according to an exemplary embodiment of the present invention.

### DETAILED DESCRIPTION OF THE PREFERRED EMBODIMENT

A preferred embodiment of the present invention will now be described in detail with reference to the accompanying drawings. In the drawings, the same or similar elements are denoted by the same reference numerals even though they are depicted in different drawings. In the following description, a detailed description of known functions and configurations incorporated herein have been omitted for conciseness.

The present invention provides a method for enabling video communication reception/transmission even when a dual mode mobile terminal positioned in a CDMA/WCDMA overlap boundary, i.e. a boundary where video communication service is possible, connects with a CDMA network system.

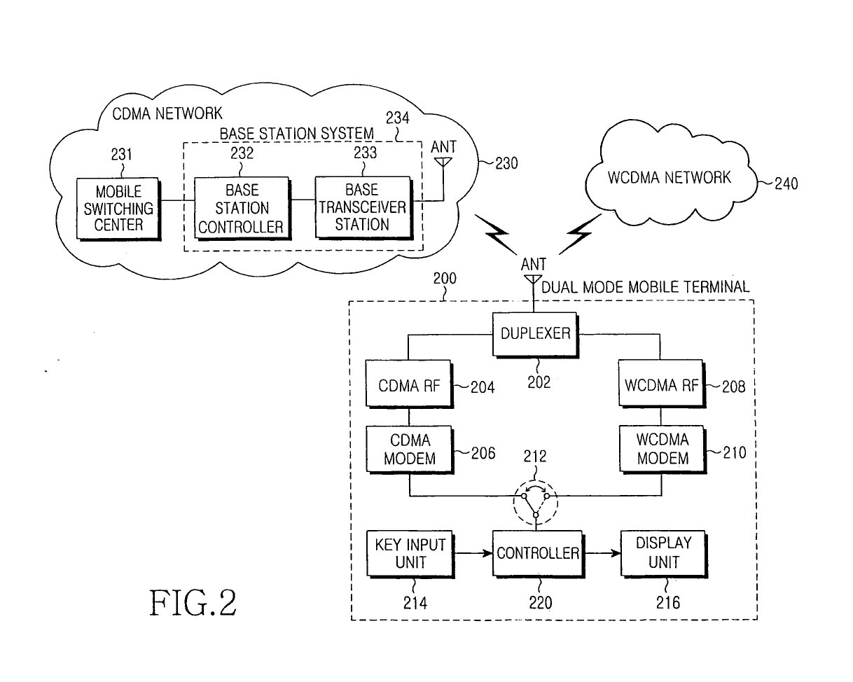

Constructions and operations of the dual mode mobile terminal and CDMA network and WCDMA network systems according to the present invention will be described with reference to FIG. 2. In the present invention, a terminal is described as the dual mode mobile terminal that can communicate with a CDMA system and a WCDMA system, but it can also be described as a multi mode mobile terminal that can operate in communication systems based on different communication modes, rather than the CDMA and WCDMA systems.

Referring to FIG. 2, the CDMA network system 230 includes a mobile switching center 231, and a Base Station System (BSS) 234 having a BS controller 232 and a Base Transceiver Station (BTS) 233.

According to the present invention, the (BSS) 234 receives a call for video communication, and when a receiver mobile terminal is positioned in a CDMA network and WCDMA network overlap boundary, transmits a message indicating a reception of the call for the video communication to the dual mode mobile terminal 200, and executes a switching to a WCDMA mode for the video communication.

In the present invention, upon the receipt of a call for video communication, a BTS 234 transmits a message indicating the reception of the call for the video communication, and the dual mode mobile terminal 200 itself directly determines whether it is in a CDMA/WCDMA overlap boundary, and then, when it is determined to be in the overlap boundary, executes a switching to a WCDMA mode for the video communication.

Herein below is a description of a construction and an operation of the mobile terminal for, upon the receipt of the call for the video communication from the CDMA network system 230 as described above, executing the switching to the WCDMA mode for the video communication and executing the video communication.

The dual mode mobile terminal 200 includes an antenna (ANT) for transmitting and receiving a CDMA signal and a WCDMA signal; a duplexer 202 for separating the CDMA signal and the WCDMA signal transmitted and received through the antenna; Radio Frequency (RF) units 204 and 208 for processing the CDMA signal and the WCDMA signal, respectively; a CDMA modem 206 and a WCDMA modem 210 for enabling an operation based on a CDMA mode or a WCDMA mode; and a controller 220 for controlling them. The respective modems 206 and 210 connect to the controller 220 through a hardware communication path. A communication port of the controller 220 is constructed to selectively connect to any one of the CDMA modem 206 and the WCDMA modem 210 using a switch 212. Also, the dual mode mobile terminal 200 includes a key input unit 214 for inputting a request for video communication reception and transmission, and a display unit 216 for displaying a process according to the execution of reception and transmission operations.

In particular, a process of executing the operation for the video communication transmission by a user in the dual mode mobile terminal 200 according to the present invention will be described herein below.

Upon the receipt of a request for the video communication transmission from the user, the controller 220 determines whether it is in the CDMA mode, and when it is determined to be in the CDMA mode, it determines whether the terminal 200 is currently positioned in the CDMA and WCDMA overlap boundary. When the terminal 200 is determined to be in the CDMA and WCDMA overlap boundary, the controller 220 automatically switches the CDMA mode to the WCDMA mode, connects to the WCDMA network system 240, and executes an operation for the video communication.

A process of executing an operation for the video communication reception when the dual mode mobile terminal 200 receives the message indicating the reception of the call for the video communication from the CDMA network system 230 will be described herein. In the CDMA network system 230, the dual mode mobile terminal 200 executes operations, according to the present invention, where a receiver terminal determines as to the CDMA/WCDMA overlap boundary and then transmits the message indicating the reception of the call for the video communication and where, upon receipt by a specific terminal of the call for the video communication, it immediately transmits the message indicating the reception of the call for the video communication to the terminal.

A process for determining a position of the receiver mobile terminal in response to the reception of the call for the video communication in the CDMA network system, and a process of, when the receiver mobile terminal is in the CDMA/WCDMA overlap boundary, transmitting the message indicating the reception of the call for the video communication to the dual mode mobile terminal 200 will be described in the first exemplary embodiment. Upon the receipt of the message indicating the reception of the call for the video communication from the CDMA network system 230 in the CDMA mode, the controller 200 signals the reception of the call for the video communication to the user. After that, when there is a reception check for execution of the video communication from the user, the controller 220 automatically switches the CDMA mode to the WCDMA mode, connects to the WCDMA network system 240, and executes the operation for the video communication.

In a second embodiment of the present invention, a process of, upon the receipt of the call for the video communication, immediately transmitting the message indicating the reception, to the dual mode mobile terminal 200 in the CDMA network system will be described herein. The controller 200 determined whether its position is in the CDMA/WCDMA overlap boundary. If it is determined to be in the CDMA/WCDMA overlap boundary, the controller 200 automatically switches the CDMA mode to the WCDMA mode, connects to the WCDMA network system 240, and executes the operation for the video communication.

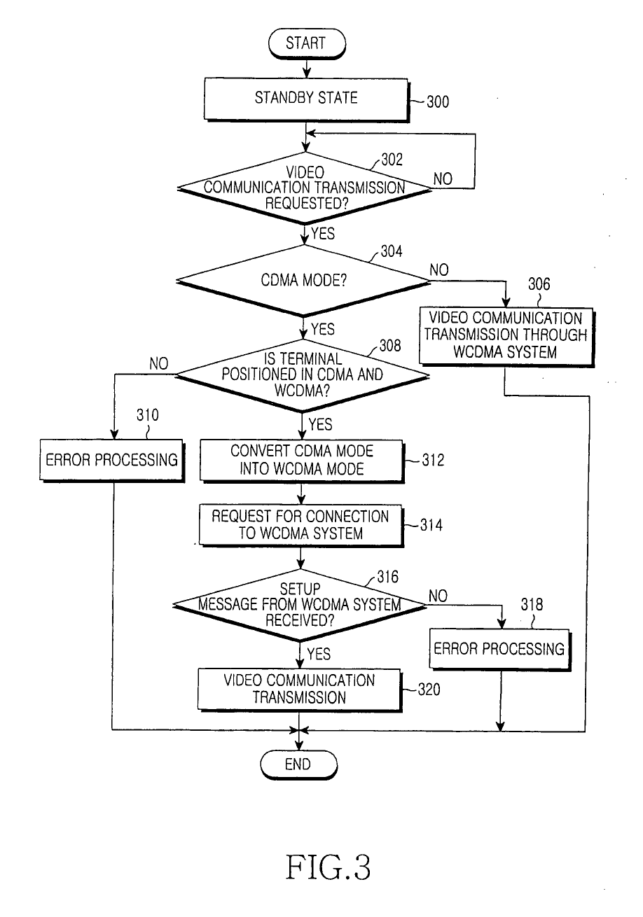

A process of executing the operation for the video communication transmission by the dual mode mobile terminal 200 in the system constructed as in FIG. 2 will be described with reference to a flowchart of FIG. 3.

Referring to FIG. 3, in Step 300, the controller 220 maintains a standby state. When there is an input for the video communication transmission from the user in step 302, the controller 220 proceeds to Step 304 and determines whether a current communication operation mode is the CDMA mode. If the determined result of the Step 304 is that the communication operation mode is the CDMA mode, the controller 220 proceeds to Step 308. Otherwise, it proceeds to Step 306 and executes the operation for the video communication transmission. Simply, if the determined result of the Step 304 is that the current communication operation mode is set to the WCDMA mode and a connection is made to the WCDMA network system, the controller 220 executes an operation for normal video communication transmission.

When the current communication operation mode is the CDMA mode in the Step 304, the controller 220 determines whether a current terminal position is in the CDMA/WCDMA overlap boundary in the Step 308. The terminal position can be determined using a bit setting value representing the CDMA/WCDMA overlap boundary and included within a system parameter message received from the CDMA network system 230.

If the determined result of the Step 308 is that the current terminal position is in the CDMA/WCDMA overlap boundary, the controller 220 proceeds with Step 312. Otherwise, the controller 220 determines that the terminal is impossible to connect to the WCDMA network, and performs an error processing operation for the video communication transmission in Step 310. The controller 220 can display a content for notifying that it is in a boundary where the video communication is currently impossible, on a screen using the display unit 216, thereby notifying it to the user.

When it is determined that the current terminal position is in the CDMA/WCDMA overlap boundary in the Step 308, the controller 220 automatically converts the CDMA mode into the WCDMA mode in the Step 312.

After that, in the Step 312, the controller 220 transmits a message of a request for a connection to the WCDMA system through the WCDMA modem 210 and the WCDMA RF 208. Next, upon the receipt of a connection accept reply message from the WCDMA system in Step 316, the controller 220 proceeds with Step 320 and performs the operation for the video communication transmission. However, upon the receipt of a connection deny reply message from the WCDMA system in the Step 316, the controller 220 performs the error processing operation for the video communication transmission. The controller 220 can display the content for notifying that it is in the boundary where the video communication is currently impossible, on a screen using the display unit 216, thereby notifying it to the user.

As described in FIG. 3, in the present invention, while the dual mode mobile terminal 200 positioned in the CDMA/WCDMA overlap boundary is in course of an operation based on the CDMA mode, when there is a request for the video communication transmission from the user, the communication operation mode is automatically converted from the CDMA mode into the WCDMA mode, thereby making the video communication transmission possible.

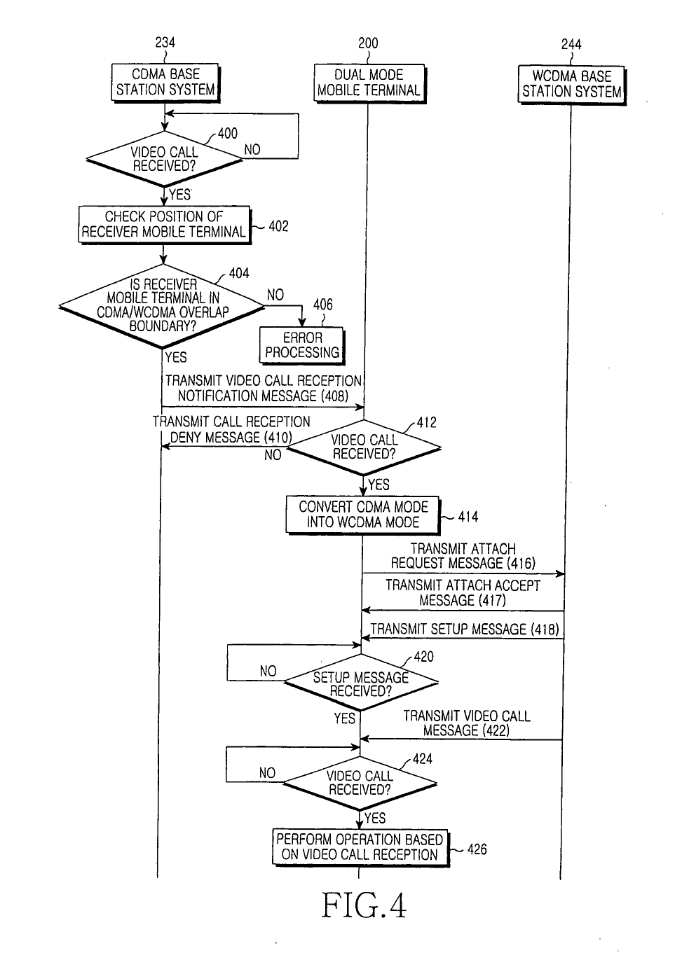

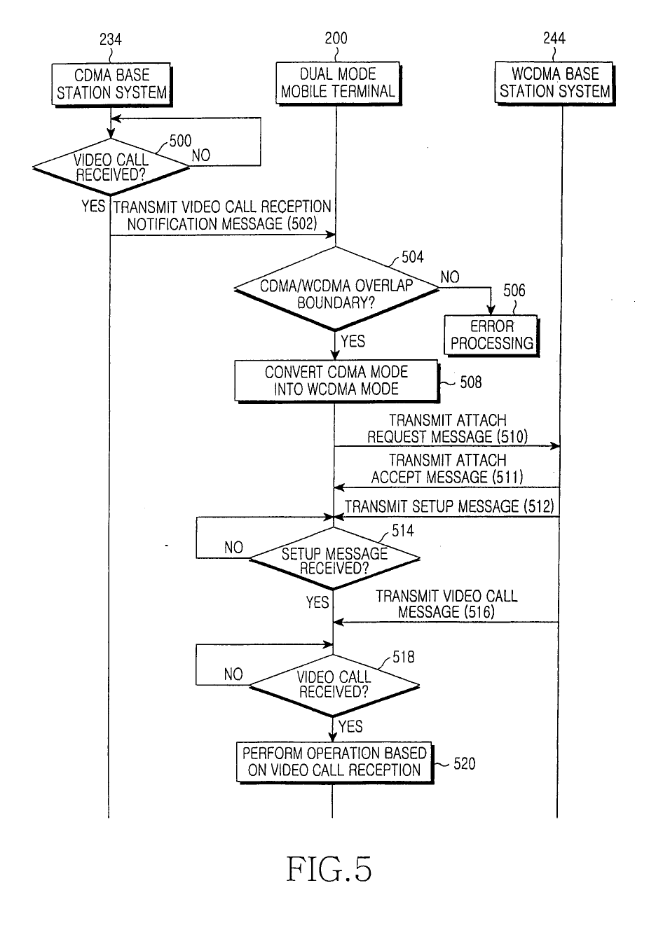

Signal flows among the CDMA BSS 234, the dual mode mobile terminal 200, and the WCDMA BSS 234, for the video communication reception by the dual mode mobile terminal 200 in the system constructed as in FIG. 2, will be described with reference to FIGS. 4 and 5.

First, the signal flow between the CDMA network and WCDMA network systems and the dual mode mobile terminal, for processing the video communication reception by the dual mode mobile terminal according to the first embodiment of the present invention will be described with reference to FIG. 4.

Upon the receipt of the call for the video communication in Step 400, the CDMA base station system 234 determines a position of the receiver mobile terminal for the call in Step 402. After that, in Step 404, the CDMA BSS 234 determines whether the receiver mobile terminal is positioned in the CDMA/WCDMA overlap boundary. Simply, in the CDMA BSS 234, it is determined whether the system to which the receiver mobile terminal is currently registered in its position is in a boundary where even the WCDMA communication is possible. The video communication is not possible if the receiver mobile terminal is not positioned in the CDMA/WCDMA overlap boundary and thus, an error processing operation is executed in Step 406. If the determined result of the Step 404 is that the receiver mobile terminal is positioned in the CDMA/WCDMA overlap boundary, the CDMA BSS 234 transmits a message indicating the reception of the call for the video communication to the dual mode mobile terminal 200 in Step 408. The video call reception notification message transmitted to the dual mode mobile terminal 200 from the CDMA BSS 234 can also employ a feature notification message or a data burst message. In case where the receiver terminal operates in the CDMA mode, a time for, after switching the CDMA mode to the WCDMA mode for the video communication, connecting with the WCDMA network system is needed. Thus, it is required to adjust a call standby time considering all switching and the time taken to connect with the WCDMA network system. A transmitter terminal displays that the receiver terminal is currently in course of a mode switching request in a CDMA boundary, using an Unstructured Supplementary Service Data (USSD) message, so that a transmitter terminal user can wait.

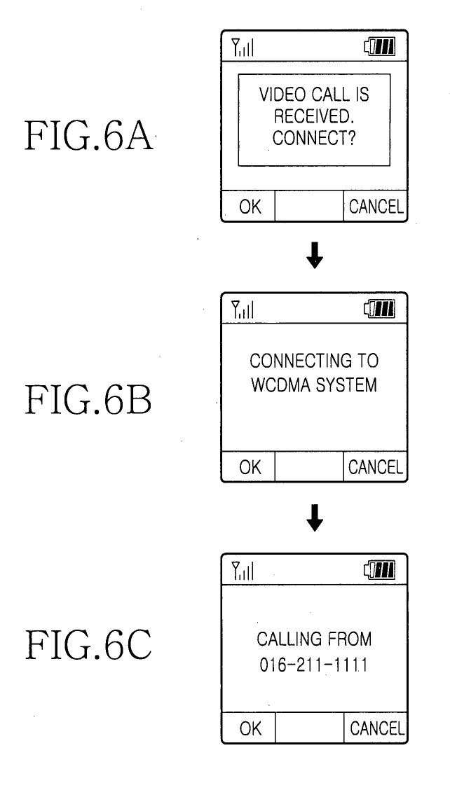

The dual mode mobile terminal 200 receiving the video call reception notification message from the CDMA BSS 234, as described above, notifies the user that the call for the video communication is currently received. In order to notify to the user the reception of the call for the video communication, content as shown in FIG. 6A, “Video communication is received. Connect?”, can be displayed using the display unit 216.

Thereafter, during the reception check for connection from the user in Step 412, the dual mode mobile terminal 200 proceeds to Step 414. Otherwise, the dual mode mobile terminal 200 transmits a call reception deny message to the CDMA BSS 234 in Step 410. When there is the reception check for connection from the user, the dual mode mobile terminal 200 displays a content of FIG. 6B on the screen while executing Steps 414 to 420 below.

Following Step 412, in Step 414, the dual mode mobile terminal 200 switches the CDMA mode, which is the currently set communication operation mode to the WCDMA mode. After that, the dual mode mobile terminal 200 transmits an attach request message to the WCDMA BSS 244 in Step 416 to receive the video communication. The WCDMA BTS 244 receiving it transmits an attach accept message to the dual mode mobile terminal 200 in Step 417, and transmits a setup message to the dual mode mobile terminal 200 in Step 418.

The dual mode mobile terminal 200 determines whether it receives the setup message in Step 420. Upon the receipt of the setup message, the dual mode mobile terminal 200 proceeds to Step 424 and determines whether it receives a video call message from the WCDMA BSS 234. Upon receipt of the video call message, the dual mode mobile terminal 200 proceeds to Step 426 and executes an operation based on the reception of the video call message. The operation based on the reception of the video call message of Step 426 is the same as an operation of processing a call message received for video communication from a general WCDMA system. Thus, its description will be omitted in the present invention. According to the reception of the video call message, the dual mode mobile terminal 200 can display a content of FIG. 6C on the screen in Step 426.

When there is a request for a call termination from the transmitter terminal in execution of Step 400 to step 426, the CDMA BSS 234 transmits a message for the call termination to the dual mode mobile terminal 200 that is the transmitter terminal, thereby indicating that a video communication call connection is terminated.

The signal flow between the CDMA network and WCDMA network systems and the dual mode mobile terminal, for processing the video communication reception by the dual mode mobile terminal according to a second embodiment of the present invention, will be described with reference to FIG. 5.

Upon the receipt of a call for video communication in Step 500, a CDMA BSS 234 transmits a message of notifying the reception of the call for the video communication to the dual mode mobile terminal 200 in Step 502. The video call reception notification message transmitted from the CDMA BSS 234 to the dual mode mobile terminal 200 can also employ a feature notification message or a data burst message.

Upon the receipt of the video call reception notification message, in Step 504, the dual mode mobile terminal 200 determines whether its current position is in a CDMA/WCDMA overlap boundary. If the determined result is that the dual mode mobile terminal 200 is currently in the CDMA/WCDMA overlap boundary, the dual mode mobile terminal 200 proceeds to Step 508. Otherwise, the dual mode mobile terminal 200 proceeds to Step 506 and notifies to a user that video communication is impossible, and executes an error processing operation. The dual mode mobile terminal 200 can display contents shown in FIGS. 6A and 6B on a screen, thereby notifying to the user that a switching to a WCDMA mode is being currently executed in response to the video call reception.

In Step 508, the dual mode mobile terminal 200 switches a CDMA mode, which is a currently set communication operation mode, to the WCDMA mode. Thereafter, in Step 510, the dual mode mobile terminal 200 transmits an attach request message to the WCDMA BSS 234 for the call communication reception. In Step 511, the WCDMA BSS 234 transmits an attach accept message as a response message responsive to the access request message received from the dual mode mobile terminal 200. After that, in Step 512, the WCDMA BSS 234 transmits a setup message to the dual mode mobile terminal 200.

In Step 514, the dual mode mobile terminal 200 determines whether it receives the setup message in Step 514. Upon the receipt of the setup message, the dual mode mobile terminal 200 proceeds to Step 518. In the Step 518, the dual mode mobile terminal 200 determines whether it receives a video call message from the WCDMA BSS 234. Upon the receipt of the video call message, the dual mode mobile terminal 200 proceeds to Step 520 and executes an operation based on the reception of the video call message. The operation based on the reception of the video call message of the Step 520 is the same as an operation of processing a call message received for video communication from a general WCDMA system. Thus, its description will be omitted herein. In response to the reception of the video call message, the dual mode mobile terminal 200 can display a content of FIG. 6C on the screen in Step 520.

As described in FIGS. 4 and 5, in the present invention, in case where there is the video communication reception by the dual mode mobile terminal positioned in the CDMA/WCDMA overlap boundary, when the terminal is operating in the CDMA mode, it is automatically switched in its mode to the WCDMA mode, thereby enabling the video communication reception.

As described above, in the present invention, there is an advantage that, when the dual mode mobile terminal positioned in the CDMA/WCDMA overlap boundary connects to the CDMA network system, the CDMA mode is automatically switched to the WCDMA mode, thereby enabling the video communication reception/transmission.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for providing a video communication service of a dual mode mobile terminal in a system having a dual mode mobile terminal that can communicate with a first communication system and a second communication system providing the video communication service, the method comprising the steps of:
upon receipt by dual mode mobile terminal of a call for video communication, in the first communication system, transmitting a video call reception notification message for indicating to the dual mode mobile terminal that a video call is received, depending on whether the dual mode mobile terminal is positioned in an overlap boundary of the first and second communication systems; and
in the dual mode mobile terminal, upon receipt of the video call reception notification message, switching a first communication mode for communication with the first communication system into a second communication mode for communication with the second communication system, and executing an operation based on video call reception using the second communication system.

2. The method of claim 1, further comprising a step of, in the dual mode mobile terminal, upon the receipt of the video call reception notification message, displaying on a screen a message of indicating the reception of the video call reception notification message.

3. The method of claim 1, further comprising a step of, in the dual mode mobile terminal, as switching the first communication mode into the second communication mode, transmitting a message of a request for a connection to the second communication system, and displaying, on a screen, a message of indicating that it is in course of the connection to the second communication system.

4. The method of claim 1, wherein the first communication system is a Code Division Multiple Access CDMA ( ) system, the second communication system is a Wideband Code Division Multiple Access (WCDMA) system, the first communication mode is a CDMA mode, and the second communication mode is a WCDMA mode.

5. A method for providing a video communication service of a dual mode mobile terminal in a system having the dual mode mobile terminal that can communicate with a first communication system and a second communication system enabling the video communication service, the method comprising the steps of:
upon receipt by the dual mode mobile terminal of a call for video communication, in the first communication system, transmitting a video call reception notification message indicating that a video call is received, to the dual mode mobile terminal; and
in the dual mode mobile terminal, upon receipt of the video call reception notification message, determining whether it is positioned in an overlap boundary of the first and second communication systems, and, when it is positioned in the overlap boundary of the first and second communication systems, switching a first communication mode for communication with the first communication system to a second communication mode for communication with the second communication system, and executing an operation based on video call reception using the second communication system.

6. The method of claim 5, further comprising a step of, in the dual mode mobile terminal, as switching the first communication mode to the second communication mode, transmitting a message of a request for a connection to the second communication system, and displaying, on a screen, a message of indicating that it is in course of the connection to the second communication system.

7. The method of claim 5, wherein the first communication system is a Code Division Multiple Access (CDMA) system, the second communication system is a Wideband Code Division Multiple Access (WCDMA) system, the first communication mode is a CDMA mode, and the second communication mode is a WCDMA mode.

8. A method for controlling video communication transmission in a dual mode mobile terminal in a system having the dual mode mobile terminal that can communicate with a first communication system and a second communication system providing a video communication service, the method comprising the steps of:
when there is an input for the video communication transmission, determining whether a communication operation mode is a first communication mode for communication with the first communication system, and, when the communication operation mode is the first communication mode, determining whether a current position is in an overlap boundary of the first and second communication systems;
when the check result is that the current position is in the overlap boundary of the first and second communication systems, switching the first communication mode to a second communication mode for communication with the second communication system; and
in response to the switching to the second communication mode, executing an operation based on video call reception using the second communication system.

9. The method of claim 8, wherein the first communication system is a Code Division Multiple Access (CDMA) system, the second communication system is a Wideband Code Division Multiple Access (WCDMA) system, the first communication mode is a CDMA mode, and the second communication mode is a WCDMA mode.

10. A system having a dual mode mobile terminal that can communicate with a first communication system and a second communication system enabling a video communication service, and providing the video communication service of the dual mode mobile terminal, the system comprising:
the first communication system for, upon receipt by the dual mode mobile terminal of a call for video communication, transmitting a video call reception notification message indicating to the dual mode mobile terminal that a video call is received, depending on whether the dual mode mobile terminal is positioned in an overlap boundary of the first and second communication systems; and
the dual mode mobile terminal for, upon receipt of the video call reception notification message, switching a first communication mode for communication with the first communication system to a second communication mode for communication with the second communication system, and performing an operation based on video call reception using the second communication system.

11. The system of claim 10, wherein, upon the receipt of the video call reception notification message, the dual mode mobile terminal displaying, on a screen, a message indicating that the video call reception notification message is received.

12. The system of claim 10, wherein, upon switching the first communication mode to the second communication mode, the dual mode mobile terminal transmits a message of a request for a connection to the second communication system, and displays, on a screen, a message indicating that it is in course of the connection to the second communication system.

13. The system of claim 10, wherein the first communication system is a Code Division Multiple Access (CDMA) system, the second communication system is a Wideband Code Division Multiple Access (WCDMA) system, the first communication mode is a CDMA mode, and the second communication mode is a WCDMA mode.

14. A system having a dual mode mobile terminal that can communicate with a first communication system and a second communication system enabling a video communication service, and providing the video communication service of the dual mode mobile terminal, the system comprising:
the first communication system for, upon receipt by the dual mode mobile terminal of a call for video communication, transmitting a video call reception notification message indicating to the dual mode mobile terminal that a video call is received; and
the dual mode mobile terminal for, upon receipt of the video call reception notification message, determining whether it is positioned in an overlap boundary of the first and second communication systems, and, when it is positioned in the overlap boundary of the first and second communication systems, switching a first communication mode for communication with the first communication system to a second communication mode for communication with the second communication system, and executing an operation based on video call reception using the second communication system.

15. The system of claim 14, wherein, upon switching the first communication mode into the second communication mode, the dual mode mobile terminal transmits a message of a request for a connection to the second communication system, and displays, on a screen, a message indicating that it is in course of the connection to the second communication system.

16. The system of claim 14, wherein the first communication system is a Code Division Multiple Access (CDMA) system, the second communication system is a Wideband Code Division Multiple Access (WCDMA) system, the first communication mode is a CDMA mode, and the second communication mode is a WCDMA mode.

17. A dual mode mobile terminal for controlling video communication transmission in a system having the dual mode mobile terminal that can communicate with a first communication system and a second communication system enabling a video communication service, the terminal comprising:
a first modem for performing a first communication mode for communication with the first communication system;
a second modem for performing a second communication mode for communication with the second communication system; and
a controller for, when there is an input for video communication transmission, determining whether a communication operation mode is the first communication mode, and, when the communication operation mode is the first communication mode, determining whether a current position is in an overlap boundary of the first and second communication systems, and, when the current position is in the overlap boundary of the first and second communication systems, switching the first communication mode to the second communication mode for the communication with the second communication system, and executing an operation based on video call reception using the second communication system.

18. The terminal of claim 17, wherein the first communication system is a Code Division Multiple Access (CDMA) system, the second communication system is a Wideband Code Division Multiple Access (WCDMA) system, the first communication mode is a CDMA mode, and the second communication mode is a WCDMA mode.

19. A dual mode mobile terminal for controlling video communication transmission in a system having the dual mode mobile terminal that can communicate with a first communication system and a second communication system enabling a video communication service, the terminal comprising:
a first modem for performing a first communication mode for communication with the first communication system;
a second modem for performing a second communication mode for communication with the second communication system; and
a controller for, upon receipt of a video call reception notification message from the first communication system in execution of the first communication mode, switching the first communication mode to the second communication mode, and executing an operation based on video call reception using the second communication system.

20. The terminal of claim 19, wherein, upon the receipt of the video call reception notification message, the controller displays, on a screen, a message indicating that the video call reception notification message is received.

21. The terminal of claim 19, wherein, upon switching the first communication mode to the second communication mode, the controller transmits a message of a request for a connection to the second communication system, and displays, on a screen, a message indicating that it is in course of the connection to the second communication system.

22. The terminal of claim 19, wherein the first communication system is a Code Division Multiple Access (CDMA) system, the second communication system is a Wideband Code Division Multiple Access (WCDMA) system, the first communication mode is a CDMA mode, and the second communication mode is a WCDMA mode.

23. A dual mode mobile terminal for controlling video communication reception in a system having the dual mode mobile terminal that can communicate with a first communication system and a second communication system enabling a video communication service, the terminal comprising:
a first modem for performing a first communication mode for communication with the first communication system;
a second modem for performing a second communication mode for communication with the second communication system; and
a controller for, upon receipt of a video call reception notification message from the first communication system in execution of the first communication mode, determining whether it is in an overlap boundary of the first and second communication systems, switching the first communication mode to the second communication mode, and executing an operation based on video call reception using the second communication system.

24. The terminal of claim 23, wherein, upon switching the first communication mode to the second communication mode, the controller transmits a message of a request for a connection to the second communication system, and displays, on a screen, a message indicating that it is in course of the connection to the second communication system.

25. The terminal of claim 23, wherein the first communication system is a Code Division Multiple Access (CDMA) system, the second communication system is a Wideband Code Division Multiple Access (WCDMA) system, the first communication mode is a CDMA mode, and the second communication mode is a WCDMA mode.
